(19) United States
(12) Patent Application Publication
(10) Pub. No.: US 2024/0417131 A1
(43) Pub. Date: Dec. 19, 2024

(54) RECYCLABLE POURING SPOUT DEVICE

(71) Applicant: Daniel VIEL, ARBENT (FR)

(72) Inventor: Daniel VIEL, ARBENT (FR)

(21) Appl. No.: 18/705,070

(22) PCT Filed: Oct. 26, 2022
(86) PCT No.: PCT/FR2022/052039

§ 371 Date: May 21, 2024

(30) Foreign Application Priority Data
Oct. 26, 2021 (FR) FR2111348

(51) Int. Cl. B65D 5/74; B29C 45/16

(52) U.S. Cl. CPC B65D 5/746; B29C 45/1676

(57) ABSTRACT

A pouring spout device for packaging, including: a surround provided with a pouring opening, a cap connected to the surround by a hinge, the cap being configured to pivot between a closed position, in which the cap closes the pouring opening, and an open position, in which the cap frees the pouring opening, a plastic sealing part on the cap is arranged on an external face of the cap and extends along the edge of the cap, the sealing part comprising two lateral sealing portions which project from the lateral sides of the cap and a connecting portion connecting the two lateral portions and projecting from an upper side of the cap, the two lateral portions and the connecting portion being configured to bear against a surface of the surround when the cap is in the closed position.

### CROSS REFERENCE TO RELATED APPLICATIONS

This application is a National Stage of PCT Application No. PCT/FR2022/052039 filed on Oct. 26, 2022, which claims priority to French Patent Application No. 21/11348 filed on Oct. 26, 2021, the contents each of which are incorporated herein by reference thereto.

### TECHNICAL FIELD

The present disclosure relates to a pouring spout device intended to be disposed on a packaging to facilitate the pouring of its contents. The present disclosure also concerns a method for manufacturing such a device.

### BACKGROUND

Many plastic packaging containing dry food, phytosanitary products, litter, coatings, or other products in granular form, etc. are provided with pouring spout devices, themselves made of plastic material. These are mostly made of a bi-material plastic, which reduces their ability to be recycled, as well as the associated packaging.

At the same time, we are seeing the rise of an increasingly marked craze among consumers and certain manufacturers for recyclable packaging, such as that made of thin paper or thicker and more rigid paper, derived from cellulose, such as cardboard. However, no alternative to the pouring spouts made of plastic, which is ecological and effective, exists on the market. Also, one of the aims of the present disclosure consists in proposing a pouring spout device which responds to the problem referred to above, which can be produced at low cost, for large-scale use and which is competitive with the completely plastic pouring spout.

### BRIEF SUMMARY

To this end, the present disclosure concerns a pouring spout device for a packaging, the pouring spout device comprising:
a frame intended to be fastened to the packaging, the frame being provided with a pouring opening,
a cover connected to the frame by two flanges and a hinge, the hinge delimiting a lower side of the cover, the cover being configured to pivot between a closed position in which the cover shuts off the pouring opening and an open position in which the cover releases the pouring opening,
a sealing part made of plastic material overmolded on the cover and disposed on at least part of an external face of the cover, extending along the edge of the cover,
the sealing part comprising two lateral sealing portions which protrude respectively from the two lateral sides of the cover and a connecting sealing portion connecting the two lateral sealing portions and protruding from an upper side of the cover,
the two lateral sealing portions and the connecting sealing portion being configured to bear against an external surface of the frame in the closed position of the cover.

The device thus configured contains such a minimal amount of plastic material that the entire pouring spout device may be recycled, when the frame and the cover are made of recyclable materials. In addition, the sealing part covering the inner edge of the frame, the pouring spout device is sealed in the closed position of the cover. This is particularly useful when the content of the packaging is sensitive to humidity.

In the present document, the terms ‘lower’, ‘upper’, ‘external’ and ‘internal’ are defined when the pouring spout device is fastened to a packaging, the packaging being disposed in the ‘storage’ condition of its content.

Concretely, the pouring spout device is bi-material.

Advantageously, the frame and the cover are made of rigid material.

The rigid material is devoid of plastic material, it is in particular devoid of polyethylene or polypropylene.

According to a particular embodiment, the pouring spout device comprises two sealing elements made of a film of plastic material overmolded on the frame, each of the sealing elements being disposed on at least part of the external surface of the frame, extending at least along part of a lateral edge laterally delimiting the pouring opening, so that the sealing elements are in contact with the sealing part in the closed position of the cover. This configuration makes it possible to improve the sealing of the pouring opening of the pouring spout.

According to one arrangement, the two flanges are each made of a film of plastic material.

Concretely, the two flanges each have at least three fold lines configured so that, in the closed position of the cover, the two flanges are each folded down under the internal surface of the cover, above the pouring opening of the frame. Thus, the sealing part is in direct contact with the two sealing elements in the closed position of the cover.

As indicated above, the terms “internal surface” in the present document mean a surface intended to face the inside of the packaging.

According to another possibility, the pouring spout device comprises a fastening part made of a film of plastic material overmolded on the frame, the fastening part being disposed on at least partially the external surface of the frame by extending along an external peripheral edge of the frame. This fastening part is intended to allow fastening to the packaging, for example by welding. When the packaging is of the paper type, a very thin sealing protective film, made of synthetic and/or biosourced plastic in particular formed from protein, is generally affixed to the inner wall of the packaging (and more precisely of the width of the packaging) in particular to guarantee the sealing of the container. It is then easy to use this protective film for fastening the pouring spout device via the fastening part made of overmolded plastic film.

Thus designed, the pouring spout device according to the present disclosure comprises less than one gram of plastic for a device of approximately 5 cm by 8 cm.

In the absence of this fastening part made of plastic material and/or in the absence of the plastic film on the inner wall of the packaging, the pouring spout device is fastened to the packaging through a glue of paper glue type.

According to one possibility, the fastening part envelops a ridge of the external peripheral edge of the frame.

Concretely, the cover, the hinge and the frame are made of cellulose, in particular cardboard. The cardboard is in fact formed from cellulose having the form of a thick sheet. The cardboard sheet has a basis weight greater than 224 g/m², which gives it the rigidity necessary for holding it on the packaging and for handling it.

However, the cellulose and in particular the cardboard is a difficult material to work with, especially when it is necessary to use pieces of very precise dimensions, as is the case in the present disclosure. Indeed, the overmolding of a more or less fluid material on a solid piece requires the use of a mold with an accuracy of about one tenth of a millimeter. This makes it possible to avoid the infiltration of the material outside the overmolding regions designed to receive said material to be overmolded and to cover undesired regions of the solid piece. However, regardless of the obtaining method used to date to obtain a piece made of cardboard, the dimensions cannot achieve a precision beyond a range comprised between 4 and 6 tenths of a millimeter, which is far from the constraints to be observed for an overmolding operation. The cardboard is indeed compressed during the cutting operation so that a variation in dimension is observed between the cut line and the final piece obtained. In addition, the cardboard very easily absorbs humidity from the atmosphere, which induces dimensional changes in the plane as well as according to the thickness. Depending on whether the manufacture of the cardboard is carried out in a humid or dry atmosphere, the formed piece will have a dimensional difference, the same applies to the cutting of the cardboard piece (i.e. cover and hinge frame). As a result, it is difficult to obtain cardboard pieces for pouring spouts of precise and identical dimensions from one batch to another.

According to one possibility, the frame and/or the cover comprises a series of through holes configured to receive the overmolded plastic material. This makes it possible to reinforce the hold of the plastic material on the material constituting the frame and/or the cover.

The series of through holes is advantageously disposed under the fastening part and/or under the sealing part.

According to one arrangement, the two sealing elements are produced by molding with the sealing part, each of the two flanges is produced by molding with the sealing part, and/or the fastening part is produced by molding with the sealing part. This facilitates the overmolding, which is carried out in a single step.

According to one characteristic, the plastic material is biosourced. It is formed in particular from corn, seaweed, sugar cane, wheat, animal protein, for example milk proteins, and in particular from casein and/or caseinate, etc. This guarantees a pouring spout device completely ecological and easily recyclable.

The term “biosourced”, means in the present document ‘made from materials of biological origin’.

It is understood that the plastic material used is a thermoplastic material.

According to a particular embodiment, the connecting sealing portion comprises a gripping portion configured to allow gripping of the cover.

According to one possibility, the frame comprises a notch configured to be snap-fitted to a tooth.

In a complementary manner, the gripping portion comprises a tooth configured to be snap-fitted to said notch and to fasten the cover to the frame in the closed position of the cover. Thus the cover is removably locked.

According to one variant, the pouring spout device comprises a third connecting sealing element made of a film of plastic material overmolded on the frame, connecting the two sealing elements so as to form a sealing assembly configured to enter into contact with the sealing part in the closed position of the cover. This arrangement makes it possible to achieve a large contact surface between the sealing part and the sealing assembly made of plastic film, allowing a very good sealing of the device in the closed position of the cover.

According to one possibility, the third connecting sealing element is disposed on at least part of the external face of the frame and extends at least along part of the lateral edge laterally delimiting the pouring opening of the frame.

According to one arrangement, the sealing part comprises a closing lip extending at least partially along an inner margin of the sealing part so as to cooperate with the sealing assembly in the closed position of the cover.

According to one possibility, the closing lip is configured to cooperate with an inner margin of the sealing assembly. This arrangement allows the contact between an external peripheral edge of the closing lip and a lateral edge laterally delimiting the pouring opening in the closed position of the cover for a very good sealing of the device.

Concretely, the closing lip comprises at least one snap-fitting means configured to be snap-fitted to the sealing assembly in the closed position of the cover. Thus, the snap-fitting means made of plastic material cooperates with the sealing assembly also made of plastic material for a very good cooperation between them.

According to one possibility, the cover and the frame are formed from a piece made of cardboard and each comprise at least one compressed region adjoining an overmolded region. An overmolded region is a cardboard region determined and parameterized for the overmolding of the biosourced material, for example the sealing part and at least the two sealing regions. This configuration makes it possible to compensate for the variations in size of the cardboard piece constituting the frame and the cover. The interstices being filled, this configuration avoids the undesirable infiltration of biosourced plastic material in the compressed regions outside the overmolding regions of the cardboard, as well as in the grooves of the cardboard.

When the present disclosure provides a third connecting sealing element, the frame also comprises a compressed region adjoining the third connecting sealing element.

According to one arrangement, the compressed regions delimit the outline of the overmolding regions.

According to one arrangement, the compressed regions delimit the entire outline of the overmolding regions.

According to a second aspect, the present disclosure proposes a method for manufacturing a pouring spout device as described above, the method comprising the following steps:
a) providing a frame provided with a pouring opening and a cover connected to the frame by a hinge,
b) providing a mold configured so that the cover is disposed in the open position, and
c) overmolding the plastic material on the frame and the cover in the open position, so as to form at least one sealing part on the part of an external face of the cover.

According to one arrangement, the overmolding step c) further comprises the formation of the two sealing elements and the fastening part on the external edge of the frame.

According to one possibility, the overmolding step c) also comprises the formation of each of the two flanges on either side of the hinge.

According to one arrangement, the packaging is based on cellulose and/or plastic material.

According to one possibility, the cover and the frame are formed from a piece made of cardboard and the mold provided in step b) is configured to apply a pressure to at least one region of the cover and at least one region of the frame adjoining respectively the sealing part and at least the two sealing regions, so as to obtain the compressed regions.

As seen above, the compressed regions delimit the outline of the molding regions, or even delimit the entire outline of the molding regions.

According to one possibility, the mold comprises at least one cavity, a first surface of which is shaped to receive the biosourced plastic material and lead to overmolding at atmospheric pressure of the at least one overmolding region.

According to another possibility, the mold comprises at least one cavity, a second surface of which is shaped to compress at least one region of the frame and/or of the cover and form at least one compressed region delimiting the outline of the at least one overmolding region.

Thus, the mold of the present disclosure is configured to carry out an overmolding without applying pressure to the biosourced plastic to obtain the overmolding regions and also to apply a pressure to regions delimiting the outline of the overmolding regions.

This configuration makes it possible to avoid the infiltration of the biosourced plastic material during the overmolding of step c) into grooves of the mold and/or into the material of the frame and the cover, in particular when it is made of cardboard.

According to one arrangement, the manufacturing method comprises the injection of the biosourced plastic material, in particular made of milk proteins, according to a determined injection pressure range combined with a determined mold temperature range so as to obtain an adherence of the biosourced plastic material on the cardboard. The combination of the injection pressure and mold temperature ranges makes it possible to reach a compromise regarding the viscosity of the biosourced plastic material so as to allow the mold to be filled sufficiently quickly in the overmolding regions, and to avoid a deep infiltration in the cardboard underlying the overmolding regions which is conventionally obtained with a too low viscosity. In the same way, these ranges are determined so that the viscosity is not too high, which would prevent the penetration into the cardboard and the adherence of two materials.

The applicant has in fact been able to observe that contrary to what one might think, the use of fairly fluid biosourced plastic generates a penetration of the material into a significant thickness of cardboard, ultimately generating delamination. Furthermore, the use of a fairly hot biosourced material has the effect of damaging the surface of the cardboard so that the plastic does not adhere very well, which explains why it peels off shortly after overmolding.

Thus, by defining a pressure range, combined with a temperature range, it is possible to reach a viscosity range and a biosourced plastic resin temperature allowing an adequate penetration into the cardboard, without deforming it, in order to achieve a good adherence between the two materials.

These characteristics also make it possible to optimize an injection speed range, in particular to limit damage to the edges of the cardboard under the effect of injection.

According to other characteristics, the pouring spout device of the present disclosure includes one or several of the following optional characteristics considered alone or in combination:
The sealing part extends in the extension plane of the cover.
The two lateral sealing portions and the connecting sealing portion form a continuous sealing part.
The sealing part is overmolded on a partial length of the edge of the cover. Two portions of the edge of the cover without the sealing part extend respectively on either side of the hinge, and therefore on the lower side of the cover, so as to limit the size and facilitate the pivoting of the cover in its closed position.
The dimensions of the cover are identical to those of the pouring opening so that it can be easily manufactured before overmolding of plastic material.
The sealing part is designed to be overmolded at least partially on a ridge on the two lateral sides and a ridge on the upper side of the cover.
The connecting sealing portion comprises ribs having a thickness of at most 75% of the thickness of the tooth, so as to avoid a flattening of the tooth during the subsequent steps during the manufacture of the packaging on which the pouring spout device is fastened.
The maximum angle between the cover and the frame is approximately 120° in the open position of the cover.
The pouring opening is formed by a cutout in the material of which the pouring spout is made, the cutout delimiting the cover connected to the frame by a hinge at its lower side.
The two sealing elements cover a ridge and a wafer of said lateral edges of the frame.
The two sealing elements partially cover the external face and the internal face of the frame
The two sealing elements have a portion of U-section designed to envelop said lateral edges of the frame.
The two sealing elements are disposed face to face.
The third connecting sealing element partially covers the external face and the internal face of the frame.
The third connecting sealing element covers at least one ridge and one wafer of said lateral edge of the frame.
The third connecting sealing element has a U-section portion designed to envelop the lateral edge of the frame over at least part of the pouring opening.
the third connecting sealing element covers a lateral edge of the pouring opening.
The two sealing elements and the third connecting sealing element form a sealing assembly overmolded on the frame.
The sealing assembly is continuous.
The two flanges are each made of paper.
The two flanges each have an overall trapezoidal shape.
The two flanges each have at least one fold line.
The two flanges each have three fold lines, each of the two flanges is folded back along at least the three fold lines in the closed position of the cover.
The at least three fold lines comprise a central fold line and two lateral fold lines, on either side of the central fold line.
In the closed position of the cover, the two lateral fold lines are configured to each form a lateral fold folded down under the surface of the cover, above the pouring opening of the frame.
In the closed position of the cover, the central fold line is configured so as to form a central fold folded down towards the peripheral border of the cover.
The three fold lines are configured so that each of the two lateral folds has at least one face whose area is greater than that of the central fold.
The fastening part covers the entire external peripheral edge of the frame.
The fastening part covers the wafer and at least partially, the sole external surface of the frame. The internal surface of the frame is devoid of a fastening part.
The eternal surface of the frame is connected to the cover by the two flanges.
At least one lateral sealing portion comprises, plumb with the respective flange, a transverse projection, with respect to the longitudinal direction of extension of each lateral sealing portion, the transverse projection extending towards the center of the cover.
The third connecting sealing element is produced by molding with the two sealing elements, the sealing part and each of the two flanges.
the closing lip and the at least one snap-fitting means are produced by molding with the sealing part.
The overmolded plastic material is a biosourced plastic material.
The frame, the pouring opening and/or the cover has an overall quadrilateral shape.
The cover has an overall rectangular parallelepiped shape.
The closing lip extends at least in part along the inner margin of the two lateral sealing portions and of the connecting sealing portion.
The closing lip has an inverted U-shaped cross-section.

According to other characteristics, the pouring spout device of the present disclosure includes one or several of the following optional characteristics considered alone or in combination:
The overmolding step c) comprises the formation of the third connecting sealing element.
The overmolding step c) comprises the formation of the at least one lateral sealing portion and of the transverse projection.
The overmolding step c) comprises the formation of the closing lip.
The overmolding step c) comprises the formation of the at least one snap-fitting means.
The overmolding is performed with a single type of plastic material.

### BRIEF DESCRIPTION OF THE DRAWINGS

Other characteristics and advantages will appear on reading the detailed description below, of three non-limiting examples of implementation, made with reference to the appended figures in which:

FIG. 1 represents a perspective view of the assembly consisting of the frame of the cover and of the hinge according to one embodiment of the present disclosure.

FIG. 2 represents a perspective view of the pouring spout device comprising a sealing part on the cover, two sealing elements on the frame and two flanges connecting the frame to the cover according to one embodiment of the present disclosure.

FIG. 3 represents a rear view of the pouring spout device according to the embodiment of the present disclosure illustrated in FIG. 2.

FIG. 4 represents a bottom view of the pouring spout device according to the embodiment of the present disclosure illustrated in FIG. 2.

FIG. 5 represents a perspective view of the pouring spout device comprising a sealing part, two sealing elements, two flanges and fastening parts on the frame, according to a second embodiment of the present disclosure.

FIG. 6 represents a rear view of the pouring spout device according to the embodiment of the present disclosure of FIG. 5.

FIG. 7 represents a bottom view of the pouring spout device according to the embodiment of the present disclosure of FIG. 5.

FIG. 8 represents a perspective view of the pouring spout device according to a third embodiment of the present disclosure.

FIG. 9 represents a bottom view of the pouring spout device according to the embodiment of FIG. 8.

### DETAILED DESCRIPTION

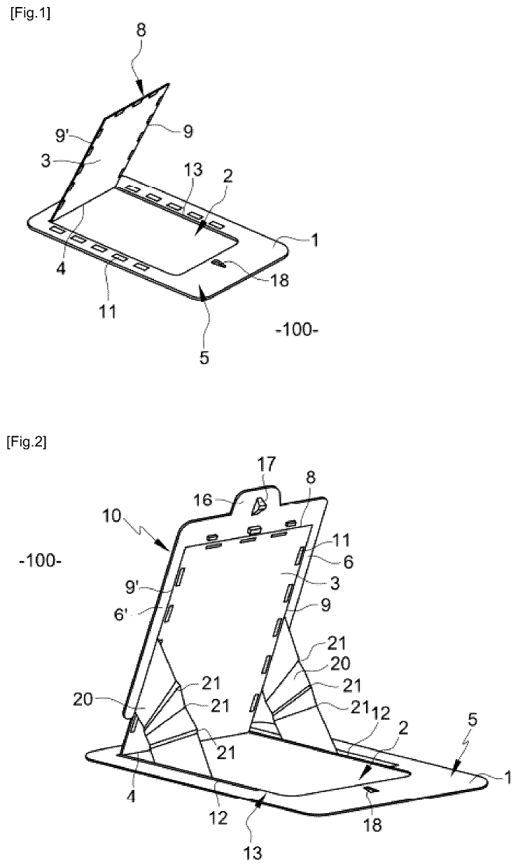

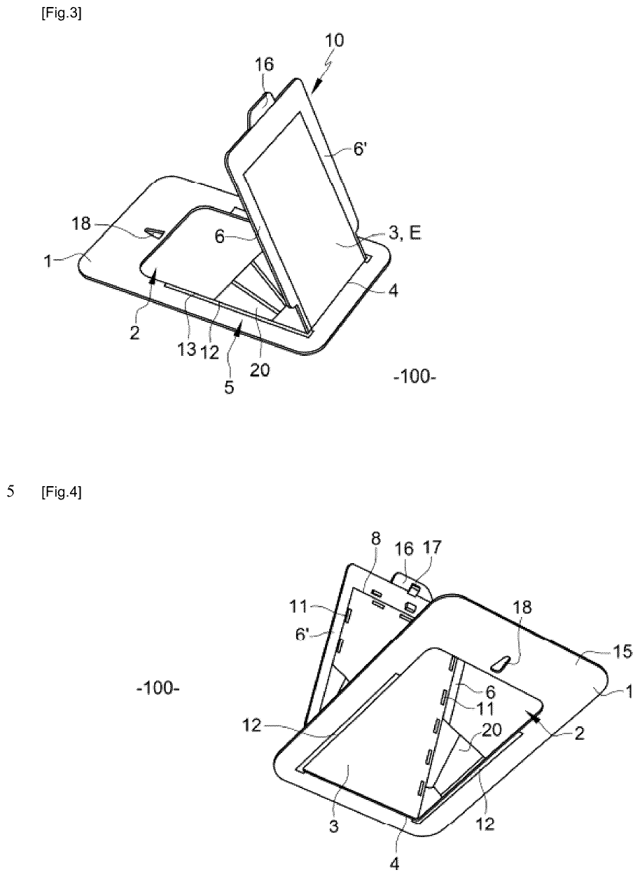

Referring to FIG. 1, the pouring spout device 100 comprises a frame 1, intended to be fastened to a packaging and in which is formed a pouring opening 2, and a cover 3, a lower side of which forms a hinge 4 connecting it to the frame 1. The cover 3 is configured to pivot between a closed position (not illustrated) in which the cover 3 shuts off the pouring opening 2 and an open position (FIGS. 1 to 7) in which the cover 3 releases the pouring opening 2. The frame 1 and the cover 3 consist of a thick sheet of a rigid cellulose material, such as cardboard, having a basis weight greater than 224 g/m2. The cover 3 advantageously comes from the cutting of the pouring opening 2 in a cardboard plate with the dimensions of the frame 1 so that the cover 3 and the pouring opening 2 have the same dimensions. As visible in the figures, the frame 1 and the cover 3 has a quadrilateral shape and in particular an overall rectangular parallelepiped shape. The lower side (or the hinge 4) of the cover 3 is formed in the direction of the width of the cover 3 but according to an alternative not illustrated, the hinge 4 is formed in the direction of the length of the cover 3. According to another alternative not illustrated, the quadrilateral is a trapezium or any parallelogram other than a rectangle.

The pouring spout device 100 according to the present disclosure further comprises a sealing part 10 made of overmolded plastic material extending in the extension plane of the cover 3, so as to extend the dimensions of the upper side 8 of the cover 3, (side opposite to the lower side forming the hinge 4) and on the two lateral sides 9, 9′ (visible in FIGS. 2 to 4). Thus, in the closed position of the cover 3, the sealing part 10 covers and bears against the external surface 5 of the frame 1, on each of the lateral edges delimiting the pouring opening 2. Concretely, the sealing part 10 comprises two lateral sealing portions 6, 6′ protruding respectively from the two lateral sides 9, 9′ of the cover 3 and a connecting sealing portion 7 connecting the two lateral sealing portions 6, 6′ protruding from the upper side 8 of the cover 3. Although this is not visible in the perspective views, the connecting sealing portion 7 comes to cover the frame 1 of the pouring spout 100 in the closed position of the cover 3.

As visible in FIGS. 2, 4 and 5, the sealing part 10 also covers part of the external face E of the cover 3 (in the form of three strips) through which is provided a series of through holes 11 (visible in FIGS. 1, 2 and following) configured to receive the overmolded plastic material. This configuration makes it possible to reinforce the hold of the sealing part 10 made of plastic on the cover 3 made of cardboard.

According to one arrangement not visible in the figures, the overmolded plastic material is advantageously made of biosourced plastic. Thus the pouring spout device 100 consisting of cellulose and biosourced plastic is completely recyclable.

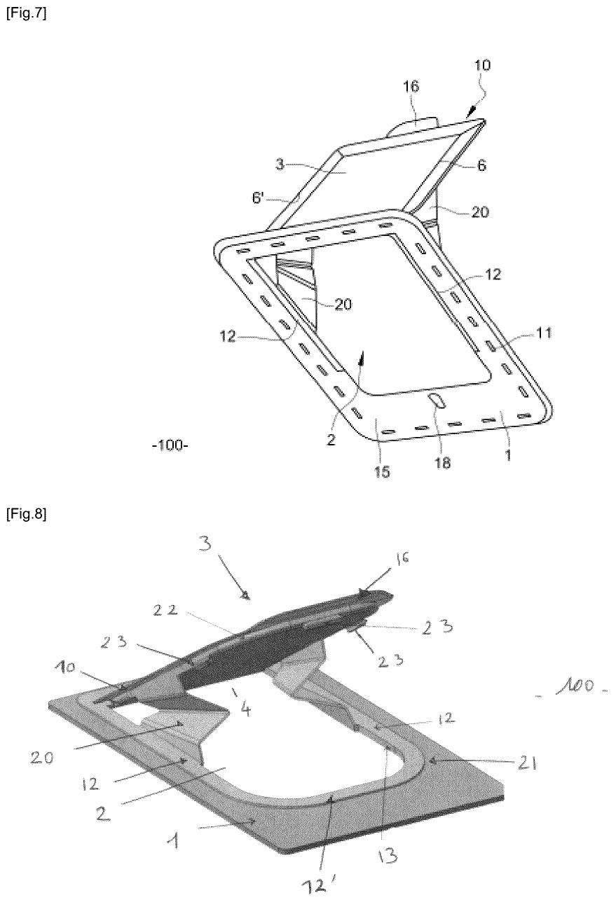

Also illustrated in FIGS. 2 to 7, the pouring spout device 100 comprises two sealing elements 12 overmolded on the frame 1. Specifically, each of the two sealing elements 12 are disposed on at least part of the external surface 5 of the frame 1, extending partially along a lateral edge 13 laterally delimiting the pouring opening 2 (FIGS. 2 to 7). These two sealing elements 12 produced by molding with the sealing part 10, each covering the wafer of a lateral edge 13 as well as part of the internal surface 15 of the frame 1 to guarantee a good hold between the two materials (FIGS. 4 and 7).

These two sealing elements 12 on the frame 1 are opposite and in contact with the two lateral sealing portions 6, 6′ of the cover 3 in the closed position of the cover 3 so as to allow a very good sealing during the shuttering of the pouring opening 2 and the conservation of the contents of the packaging.

In this embodiment, the pouring spout device 100 is fastened to the packaging by using a glue, coated on the packaging and/or on the external surface 5 of the frame 1.

Also visible in the figures, the connecting sealing portion 7 comprises a protrusion 16 forming a gripping portion configured to allow the gripping of the cover 3. This gripping portion 16 is provided with a tooth 17 configured to cooperate and be snap-fitted to a notch 18 provided in the frame 1. This arrangement makes it possible to fasten the cover 3 to the frame 1 in the closed position of the cover 3 which is then removably locked.

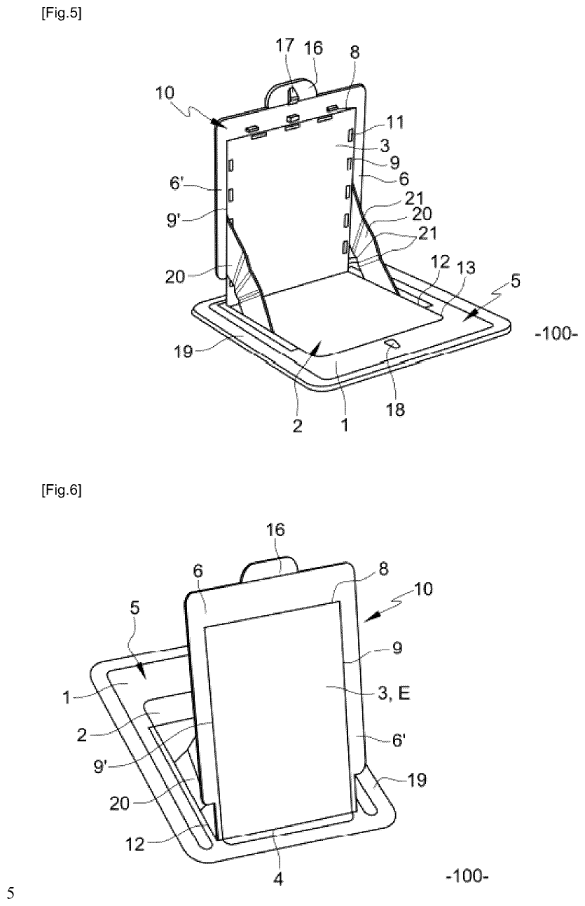

The implementation of the present disclosure as illustrated in FIGS. 5 to 7, differs from that illustrated in FIGS. 2 to 4 in particular by the provision of a fastening part 19 made of plastic film overmolded on the frame 1. The fastening portion 19 extends along an external peripheral edge of the frame 1 and a part of the external surface 5 of the frame 1 by filling a series of through holes 11 provided in the frame 1, so as to improve the holding of the plastic on the frame 1 (visible in FIG. 7). This configuration is useful to allow fastening by welding of the pouring spout 100 to the packaging. The fastening part 19 is produced by molding with the sealing part 10.

According to one possible implementation of the present disclosure, the device 100 also comprises two flanges 20 connecting the cover 3 and the frame 1. These two flanges 20 are made of a film of plastic material (refer to FIGS. 2 to 7), each produced by molding with the sealing part 10. Each of the flanges 20 comprises three fold lines 21 configured so that, in the closed position of the cover 3, the flanges 20 are each folded down under the cover 3, without coming into contact with the sealing part 10 on the cover 3 nor with the two sealing elements 12 on the frame 1. This configuration makes it possible to increase the opening angle of the cover 3 vis-à-vis the frame up to 120 degrees for example. According to another arrangement not illustrated, each of the flanges 20 have a single fold line.

According to another arrangement not illustrated, the two flanges 20 are made of cellulose, in particular paper.

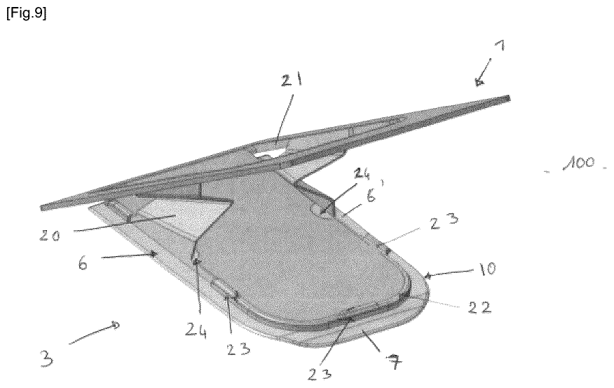

According to a third embodiment illustrated in FIGS. 8 to 9, the pouring spout device 100 differs from the previous ones described in FIGS. 1 to 7, in that it further comprises a third connecting sealing element 12′ connecting the two sealing elements 12 overmolded on the frame 1. The third connecting sealing element 12′ is made of a film of plastic material, overmolded on the frame 1 so as to be disposed on at least part of the external surface 5 of the frame 1 extending at least along part of the lateral edge 13 laterally delimiting the pouring opening 2 of the frame 1. The two sealing elements 12 and the third connecting sealing element 12′ thus form a sealing assembly 21 of the frame 1 which cooperates with the sealing part 10 in the closed position of the cover 3. According to this third embodiment illustrated in FIGS. 8 and 9, the sealing assembly 21 covers the entire lateral edge 13 of the pouring opening 2, apart of course from the hinge 4. The sealing part 10 may thus bear against the sealing assembly 21 in the closed position of the cover 3 which optimizes the sealing of the pouring spout device 100.

Also, another difference resides in that the sealing part 10 overmolded on the cover 3 comprises a closing lip 22 forming a prominence from the internal face of the cover 3 (opposite the external face E). The closing lip 22 extends at least in part along the inner margin of the sealing part 10. This closing lip 22 is configured to cooperate with the sealing assembly 21 covering a lateral edge 13 of the pouring opening 2 which extends in the direction of the thickness of the frame 1. This allows the insertion of the closing lip 22 into the pouring opening 2 when closing the cover 3 generating a tight contact between the facing surfaces of the sealing assembly 21 (outer margin) and of the sealing part 10 (inner margin).

In addition, as illustrated in FIGS. 8 and 9, the closing lip 22 is provided with three snap-fitting means, here lugs 23, configured to cooperate by snap-fitting with the lateral edge 13 of the pouring opening 2 provided with the sealing assembly 21 in order to close the pouring spout device 100 hermetically. According to another embodiment not illustrated, the closing lip 22 may comprise a single snap-fitting means 23, disposed in a central position of the connecting sealing portion 7, such as a plurality of snap-fitting means 23 distributed around the margin of the closing lip 22. It is then possible to dispense with the tooth 17 and the notch 18 of the two embodiments previously described.

As may be seen in the figures, the fastening part 19 extending along an external peripheral edge of the frame 1 may be omitted in this third embodiment as is the case in the first embodiment illustrated in FIGS. 1 to 4.

This is useful when the pouring spout device 100 is intended to be assembled with a paper packaging devoid of inner plastic film. It is possible to glue the internal face of the frame 1 made of cardboard to the paper packaging, for example via a double-sided adhesive.

When, on the contrary, the paper packaging has a plastic film on its inner surface, the presence of the fastening part 19 advantageously allows fastening by fusion of the plastics brought into contact.

Also visible in FIG. 9, each of the lateral sealing portions 6, 6′ comprises, plumb with the corresponding flange 20, a transverse projection 24, relative to the longitudinal direction of extension of each lateral sealing portion 6, 6′, the transverse projection 24 extending towards the center of the cover 1. This makes it possible in particular to hold and stiffen the cover 3 as well as the connection between the flanges 20 and the cover 3.

According to one embodiment not visible in the figures, the pouring spout device comprises at least one compressed region adjoining an overmolded region. The at least one compressed region delimits the outline of the overmolding region, such as the sealing part 10 and/or the sealing assembly 21.

According to a second aspect not illustrated, the present disclosure proposes a method for manufacturing said pouring spout device 100 comprising
a step a) of providing a frame 1 provided with a pouring opening 2 and a cover 3 connected to the frame 1 by a hinge 4, as illustrated in FIG. 1,
a step b) of providing a mold configured so that the cover 3 is disposed in the open position (also visible in FIG. 1), and
a step c) of overmolding the plastic material on the frame 1 and the cover 3 in the open position, so as to form a sealing part 10 on the peripheral margin of the cover 3 (sealing part 10 visible in FIG. 2).

Thus, the present disclosure proposes a recyclable pouring spout device 100, comprising a frame 1 and a cover 3 made of a rigid cellulose material, such as cardboard, and a sealing part 10 on the cover 3 and two sealing elements 12 on the frame 1, made of biosourced plastic material. The device 100 is configured to be easily fastened to a paper packaging (by gluing or by fusion) so as to allow a total recycling.

It goes without saying that the present disclosure is not limited to the variant embodiments described above by way of example but that it comprises all the technical equivalents and variants of the means described as well as their combinations.

1. A pouring spout device for a packaging, the pouring spout device comprising:
a frame intended to be fastened to the packaging, the frame being provided with a pouring opening,
a cover connected to the frame by two flanges and a hinge, the hinge delimiting a lower side of the cover, the cover being configured to pivot between a closed position in which the cover shuts off the pouring opening and an open position in which the cover releases the pouring opening,
a sealing part made of plastic material overmolded on the cover and disposed on at least part of an external face of the cover extending along an edge of the cover, the sealing part comprising two lateral sealing portions which protrude respectively from two lateral sides of the cover and a connecting sealing portion connecting the two lateral sealing portions and protruding from an upper side of the cover, the two lateral sealing portions and the connecting sealing portion being configured to bear against an external surface of the frame in the closed position of the cover.

2. The pouring spout device according to claim 1, which comprises two sealing elements made of a film of plastic material overmolded on the frame, each of the two sealing elements being disposed on at least part of the external surface of the frame extending at least along part of a lateral edge laterally delimiting the pouring opening, so that the two sealing elements are in contact with the sealing part in the closed position of the cover.

3. The pouring spout device according to claim 1, wherein the two flanges are each made of film of plastic material.

4. The pouring spout device according to claim 1, wherein the two flanges each have at least three fold lines configured so that, in the closed position of the cover, the two flanges are each folded down under the surface of the cover, above the pouring opening of the frame.

5. The pouring spout device according to claim 1, which comprises a fastening part made of a film of plastic material overmolded on the frame, the fastening part being disposed on at least partly the external surface of the frame extending along an external peripheral edge of the frame.

6. The pouring spout device according to claim 1, wherein the cover, the hinge and the frame are formed of cardboard.

7. The pouring spout device according to claim 1, wherein the frame and/or the cover comprises a series of through holes configured to receive the plastic material overmolded on the cover, so as to reinforce a hold of the plastic material overmolded on the cover on material constituting the frame and/or the cover.

8. The pouring spout device according to claim 2, wherein the two sealing elements are produced by molding with the sealing part, each of the two flanges is produced by molding with the sealing part, and/or the pouring spout device comprises a fastening part made of a film of plastic material overmolded on the frame, the fastening part being disposed on at least partly the external surface of the frame extending along an external peripheral edge of the frame and the fastening part is produced by molding with the sealing part.

9. The pouring spout device according to claim 1, wherein the plastic material is biosourced.

10. The pouring spout device according to claim 2, which comprises a third connecting sealing element made of a film of plastic material overmolded on the frame, the third connecting sealing element connecting the two sealing elements so as to form a sealing assembly configured to come into contact with the sealing part in the closed position of the cover.

11. The pouring spout device according to claim 10, wherein the third connecting sealing element is disposed on at least part of the external face of the frame and extends at least along part of the lateral edge laterally delimiting the pouring opening of the frame.

12. The pouring spout device according to claim 10, wherein the sealing part comprises a closing lip extending at least partially along an inner margin of the sealing part so as to cooperate with the sealing assembly in the closed position of the cover.

13. The pouring spout device according to claim 12, wherein the closing lip is configured to cooperate with an inner margin of the sealing assembly.

14. The pouring spout device according to claim 12, wherein the closing lip comprises at least one snap-fitting means configured to be snap-fitted to the sealing assembly in the closed position of the cover.

15. A method for manufacturing a pouring spout device for a packaging, the pouring spout device comprising: a frame intended to be fastened to the packaging, the frame being provided with a pouring opening, a cover connected to the frame by two flanges and a hinge, the hinge delimiting a lower side of the cover, the cover being configured to pivot between a closed position in which the cover shuts off the pouring opening and an open position in which the cover releases the pouring opening, a sealing part made of plastic material overmolded on the cover and disposed on at least part of an external face of the cover extending along an edge of the cover, the sealing part comprising two lateral sealing portions which protrude respectively from two lateral sides of the cover and a connecting sealing portion connecting the two lateral sealing portions and protruding from an upper side of the cover, the two lateral sealing portions and the connecting sealing portion being configured to bear against an external surface of the frame in the closed position of the cover, comprising the following steps of
a) providing a frame provided with a pouring opening and a cover connected to the frame by a hinge,
b) providing a mold configured so that the cover is disposed in the open position, and
c) overmolding the plastic material on the frame and the cover in the open position, so as to form a sealing part on a peripheral margin of the cover.

16. The pouring spout device according to claim 2, wherein the two flanges are each made of film of plastic material.

17. The pouring spout device according to claim 16, wherein the two flanges each have at least three fold lines configured so that, in the closed position of the cover, the two flanges are each folded down under the surface of the cover, above the pouring opening of the frame.

18. The pouring spout device according to claim 17, which comprises a fastening part made of a film of plastic material overmolded on the frame, the fastening part being disposed on at least partly the external surface of the frame extending along an external peripheral edge of the frame.

19. The pouring spout device according to claim 18, wherein the cover, the hinge and the frame are formed of cardboard.

20. The pouring spout device according to claim 19, wherein the frame and/or the cover comprises a series of through holes configured to receive the plastic material overmolded on the cover, so as to reinforce a hold of the plastic material overmolded on the cover on material constituting the frame and/or the cover.
